(19) United States
(12) Patent Application Publication
(10) Pub. No.: US 2007/0002593 A1
(43) Pub. Date: Jan. 4, 2007

(54) Isolated DCX converter

(76) Inventors: James S. Dinh, Gig Harbor, WA (US); Tomm V. Aldridge, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,404

(22) Filed: Jun. 30, 2005

(51) Int. Cl. H02M 3/335

(52) U.S. Cl. 363/25

(57) ABSTRACT

In accordance with one embodiment of the invention, the converter 100 utilizes an isolated autotransformer to provide an efficient turns ratio voltage reduction of a transformer and yet be driven by a standard buck controller.

### BACKGROUND INFORMATION

As output current demands of power sources increase and the corresponding output voltage decreases, the high efficiency (>90%) of the voltage regulator becomes more stringent and more difficult to maintain. The typical method to convert high voltage to low voltage with load variations is to use expensive transformer, FETs, capacitors.

Thus a need exists for a high efficient, low cost voltage regulator solution which is both economical and effective in maintaining efficiency of the voltage regulator. The proposed solution provides a converter that utilizes an isolated autotransformer to provide the efficient turns ratio voltage reduction of a transformer and yet be driven by a standard buck controller

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 circuit diagram illustrating an embodiment of an isolated DCX converter.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

A buck converter is a switched mode power supply that switches a first input voltage to a second, lower output voltage. Essentially, a voltage regulator, the buck converter may also be known as a down switcher, a step-down converter, and a switch mode regulator. Characteristic elements in a typical buck converter include inductors, capacitors, diodes, and metal-oxide semiconductor field-effect transistors (MOSFETs) for switching operations.

When a load is applied to the output of the buck converter, the output voltage will generally drop. The drop in voltage is due to such factors as the internal resistance, internal inductance, and other characteristics of the buck converter.

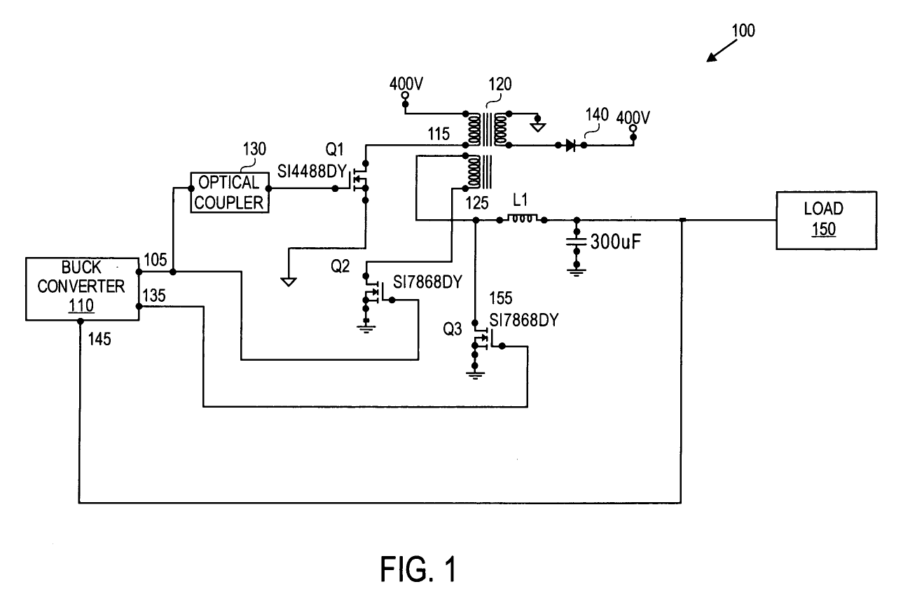

Referring now to FIG. 1, an embodiment of an isolated DCX converter 100. In the converter 100, gates Q1 and Q2 are driven by the high side driver 105 of a synchronous buck controller 110. The buck controller may be any controller well known in the art for the implementation. Gate Q2 connects the bottom of the secondary winding 125 of a transformer 120 to ground and gate Q1 connects the bottom of the primary winding 115 of the transformer 120 to ground.

The transformer 120 is an isolated autotransformer 120 with primary 115 and secondary 125 windings. Voltage may be controlled by the turns ratio of this transformer 120. In most circuits, if the voltage is higher than 48V, an isolated transformer is needed to prevent shocks from occurring.

Gate Q1 is driven by an optocoupler 130. The optocoupler 130 provides isolation to prevent sudden surges that could be dangerous from being transferred from the buck controller 110 to the gates Q1 and Q2. Thus, the optocoupler 130 could be an isolated driver. For the present solution, any optocoupler could be used based on implementation.

When the driver 130 voltage goes positive, gates Q1 and Q2 are simultaneously turned on. Gate Q3 is turned off at this time, since it is connected to the low side drive 135 of the controller 110.

When the driver 130 voltage goes positive, current flows through both primary 115 and secondary 125 windings. In addition, a voltage is induced on the secondary 125 winding connection going to Q3's drain 155 and an inductor input L1. The value of this voltage is determined by the turns ratio of these two windings 115, 125. For example, if the circuit goes from 400V to 1V, it needs to turn 400 times.

When the high side driver 105 goes low, Q1 and Q2 turn off, and Q3 turns on, pulling the input of inductor L1 low. The voltage at the input node of the inductor L1 may be a square wave with the duty cycle adjusted by the controller 110 to produce the desired output voltage across the output cap.

The primary 115 and secondary 125 transformer windings then each have one side floating, and the remaining flux in the transformer 120 begins to drop rapidly. When the high side driver 105 goes low, a positive voltage is induced from a tertiary winding in the node connected to the anode of the diode, sending a reset 140 current into a power source.

The output 145 of the controller 110 goes to a load 150. The load may be a CPU, chipset, memory, etc. In order for the converter 100 to regulate, it needs a closed loop system. Output 145 from the controller 110 provides a feedback signal to the closed loop system of the converter 100.

In the embodiment described above, the converter 100 utilizes the isolated autotransformer 120 to provide the efficient turns ratio voltage reduction of a transformer and yet be driven by a standard buck controller 110.

The converter 100 design is simple enough to allow implementation on any platform. This design may allow for the reduction of rectifier diodes, FETs, capacitor quantity. Thus, saving costs in high reliability server platforms as well as workstation and desktop applications.

Furthermore, since FETs, rectifier diode, capacitors are costly, dissipate more power and occupy board space, saving components will save Intel costs on boards having VR's either plug-in or down.

In summary, this invention protects Intel's ability to make feasible accomplishing rigid requirements of future processor families with lower voltage transient requirements and higher current requirements. In addition, this invention protects future server and desktop families' power delivery due to significant output components and size reduction. More importantly, due to future very high efficiency requirements for DC-DC converters and platforms.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

What is claimed is:

1. A converter comprising,
a buck controller; and
an isolated transformer coupled to the controller to provide efficient turns ratio voltage reduction.

2. The converter of claim 1 further comprising an optocoupler coupled to the buck controller and the transformer.

3. The converter of claim 2 wherein the transformer is driven by the buck controller.

4. The converter of claim 1 wherein the converter is an isolated DCX converter.

5. The converter of claim 3 wherein a high side driver of the controller drives gates of the controller.

6. The converter of claim 5 wherein a first gate is coupled to bottom of a primary winding of the transformer.

7. The converter of claim 6 wherein a second gate is coupled to bottom of a secondary winding of the transformer.

8. The converter of claim 7, wherein when the optocoupler goes positive, the first and second gates are turned on, causing current to flow through the primary and secondary windings.

9. The converter of claim 8, wherein when the optocoupler goes positive, a third gates turns off.

10. The converter of claim 9 wherein the third gate is coupled to a low side driver of the controller.

11. The converter of claim 10 wherein voltage is induced from a tertiary winding.

12. The converter of claim 1 wherein the controller provides a feedback signal.

13. The converter of claim 1 wherein the converter is a closed loop system.

14. A method of operating an isolated converter, the method comprising:
driving positive first and second gates;
turning on the first and second gates; and
responsive to turning on the first and second gates, flowing current through a transformer.

15. The method of claim 14 further comprising turning off a third gate.

16. The method of claim 15 wherein the flowing of current is through primary and secondary windings of the transformer.

17. The method of claim 16 further comprising providing an efficient turns ratio voltage reduction by the controller and transformer.

18. The method of claim 17 further comprising providing isolation by an optocoupler.

19. The method of claim 18 wherein the driving of the gates is by the optocoupler.

20. The method of claim 19 further comprising inducing voltage on the secondary winding.
